(19) United States
(12) Patent Application Publication
(10) Pub. No.: US 2025/0067252 A1
(43) Pub. Date: Feb. 27, 2025

(54) SYSTEMS AND METHODS FOR PREDICTIVE MAINTENANCE USING COMPUTATIONAL MODELS

(71) Applicant: Sentient Science Corporation, Buffalo, NY (US)

(72) Inventors: Keith Vergien, South Wales, NY (US); Anup Pandkar, Orlando, FL (US)

(21) Appl. No.: 18/813,816

(22) Filed: Aug. 23, 2024

Related U.S. Application Data
(60) Provisional application No. 63/534,436, filed on Aug. 24, 2023.

(51) Int. Cl. F03D 80/50

(52) U.S. Cl. CPC F03D 80/509

(57) ABSTRACT

Systems and methods are disclosed herein for predictive maintenance using computational models. The systems and methods can receive data from a supervisory control and data acquisition (SCADA) system and condition monitoring systems (CMSs), generate, using anomaly detectors, anomaly scores, and generate, using an augmented data fusion model, a health state prediction of a component of a machine. An extract, transform, and load (ETL) module can extract and transform data from a variety of sources, including SCADA systems, CMSs, and other computing devices to create model input data. A models module can analyze such model input data to determine which computational models can run on the input data. A prediction module and confidence interval data can hone the predictions created by the models module. A feedback module and the ETL module can be used on diagnostic data, configuration data, and updated SCADA and CMS data to improve the computational models.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### TECHNICAL FIELD

The present disclosure generally relates to predictive maintenance, and more particularly to systems and methods for predictive maintenance using computational models.

### RELATED APPLICATIONS

This application claims priority to and the benefit of U.S. Provisional Patent Application No. 63/534,436, filed Aug. 24, 2023, which is incorporated by reference in its entirety.

### BACKGROUND OF THE DISCLOSURE

The present disclosure generally relates to predictive maintenance, and more particularly to systems and methods for predictive maintenance using computational models.

Condition monitoring can include monitoring a condition parameter in machinery, such as vibration, temperature, or other parameters, to identify a change in that parameter that indicates the machinery may be experiencing a fault. Various condition monitoring systems (CMSs) currently exist. However, these conventional CMSs only report such changes in the machinery's parameters and offer little further insight.

A failure event experienced by the machinery—whether a reduction in normal operation of the machinery or a complete halting of the machinery—can result in extended downtime of the machinery or damage to the machinery. Performing maintenance on the machinery before one of the failure events can help prevent the downtime or damage. However, it is difficult to determine when to perform this predictive maintenance. Performing the predictive maintenance too early results in functional machinery components being replaced, which results in wasted resources and unnecessary downtime. Performing the predictive maintenance too late results in the risk of a failure event increasing.

Some entities have attempted to use machine learning to determine when to perform predictive maintenance on machinery. However, these conventional machine learning efforts have fallen short. The conventional machine learning techniques when applied to detect or predict problems with (or failures of) machinery applications often experience poor performance due to imbalanced training dataset, as machines are inherently designed to prevent failures. Therefore, the examples of failed or problematic machines are much less compared to healthy or normal machines, leading to an imbalanced training dataset. Such efforts only use conventional machine learning techniques, for example, the conventional steps of (1) generating a training dataset, testing dataset, and validation dataset; (2) training a machine learning model on the training dataset; (3) testing and validating the trained model on the testing and validation datasets; and (4) performing inference predictions using the trained model to make a prediction of whether a piece of machinery needs maintenance.

What is needed are systems and methods for predictive maintenance using computational models.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a system. The system may include a processor and a computer-readable storage medium including executable instructions. The processor, in response to executing the instructions, may be configured to receive data from a supervisory control and data acquisition (SCADA) system and a plurality of CMSs, generate, using a plurality of anomaly detectors, a plurality of anomaly scores, and generate, using an augmented data fusion model, a health state prediction.

Another aspect of the disclosure is another system. The system may include an extract, transform, and load (ETL) module configured to receive first component data pertaining to a first time period, wherein the first component data includes data from at least one of a supervisory control and data acquisition (SCADA) system or a condition monitoring system (CMS), and the first component data includes data generated from a sensor associated with a component of a machine. The system may include a models module configured to receive, as input, the first component data from the ETL module, and generate, using one or more computational models, a first prediction based on the first component data. The system may include a prediction module configured to receive the first prediction from the models module and generate a second prediction based on the first prediction and confidence interval data received by the prediction module. The system may include a feedback module configured to receive the second prediction from the prediction module, receive diagnostic data, wherein the diagnostic data includes data indicating one or more diagnostic events occurring at the machine, and determine whether the second prediction is compatible with the diagnostic data. The system may include the ETL module and the models module wherein, in response to the second prediction not being compatible with the diagnostic data, the ETL module is further configured to receive second component data pertaining to a second time period, wherein the second time period occurs at least partially after the first time period, and the models module is further configured to perform at least one remediation process based on the second component data.

Another aspect of the disclosure is a method. The method may include a method for predictive maintenance using computational models. The method may include receiving, by a computing device, first component data pertaining to a first time period, wherein the first component data includes data from at least one of a SCADA system or a CMS, and the first component data includes data generated from a sensor associated with a component of a machine. The method may include inputting, by the computing device, the first component data into a models module of a predictive maintenance system to generate a first prediction based on the first component data, wherein the models module includes one or more computational models. The method may include inputting, by the computing device, confidence interval data and the first prediction into a prediction module to generate a second prediction. The method may include inputting, by the computing device, diagnostic data and the second prediction into a feedback module, wherein the diagnostic data includes data indicating one or more diagnostic events occurring at the machine. The method may include determining, by the computing device at the feedback module, whether the second prediction is compatible with the diagnostic data. The method may include, in response to the second prediction not being compatible with the diagnostic data, receiving, by the computing device, second component data pertaining to a second time period, wherein the second time period occurs at least partially after the first time period, and inputting, by the computing device, the second component data into the models module to perform at least one remediation process.

Another aspect of the disclosure is another system. The system may include at least one processor and a non-transitory storage medium with computer-readable instructions stored thereon. The computer-readable instructions, when executed by the at least one processor, may be configured to perform one or more steps. The one or more steps may include receiving first component data pertaining to a first time period, wherein the first component data includes data from at least one of a SCADA system or a CMS, and the first component data includes data generated from a sensor associated with a component. The steps may include inputting the first component data into a models module of a predictive maintenance system to generate a first prediction based on the first component data, wherein the models module includes one or more computational models. The steps may include inputting confidence interval data and the first prediction into a prediction module to generate a second prediction. The steps may include inputting diagnostic data and the second prediction into a feedback module, wherein the diagnostic data includes data indicating one or more diagnostic events associated with the component. The steps may include determining, at the feedback module, whether the second prediction is compatible with the diagnostic data. The steps may include, in response to the second prediction not being compatible with the diagnostic data, receiving second component data pertaining a second time period, wherein the second time period occurs at least partially after the first time period, and inputting the second component data into the models module to perform at least one remediation process.

The systems and methods of the disclosure provide several technical advantages over conventional predictive maintenance efforts, including efforts using machine learning. First, an extract, transform, and load (ETL) module is able to extract and transform data from a variety of sources, including SCADA systems, CMSs, and other computing devices to create the model input data. This allows the systems and methods of the disclosure to utilize a wider variety of data, which leads to more accurate maintenance predictions. Second, a models module is able to analyze such model input data to determine which computational models can be run on such model input data, whereas conventional machine learning efforts only run one or a few models on the data regardless of whether the data is a good fit for the model(s). Using computational models selected for their proficiency on the model input data, instead of using conventional general-purpose models, results in more accurate maintenance predictions. Third, use of the prediction module and confidence interval data to hone the predictions created by the models module also increases the accuracy of predictions. Fourth, using the feedback module and ETL module on diagnostic and configuration data and updated SCADA and CMS data improves the computational models of the models module, which also improves the accuracy of the overall systems and methods.

Numerous other objects, advantages and features of the present disclosure will be readily apparent to those of skill in the art upon a review of the following drawings and description of various embodiments.

### BRIEF DESCRIPTION OF THE DRAWINGS

FIG. 1 is a schematic diagram illustrating one embodiment of a system for predictive maintenance using computational models.

FIG. 2 is a schematic diagram illustrating one embodiment of a subset of the elements of the system for predictive maintenance using computational models of FIG. 1.

FIG. 3 is a schematic diagram illustrating one embodiment of system for predictive maintenance using computational models showing data flow from various systems and devices to a predictive maintenance system.

FIG. 4A depicts a schematic diagram illustrating one embodiment of data from a supervisory control and data acquisition (SCADA) system.

FIG. 4B depicts a schematic diagram illustrating one embodiment of data from a condition monitoring system (CMS).

FIG. 4C depicts a schematic diagram illustrating one embodiment of log data from computing device associated with the wind turbine of FIG. 1.

FIG. 5 depicts a schematic diagram illustrating one embodiment of a predictive maintenance system.

FIG. 6 depicts a data flow illustrating one embodiment of systems and methods for predictive maintenance using computational models.

FIG. 7 depicts a schematic diagram illustrating one embodiment of an anomaly detection model used in a system for predictive maintenance using computational models.

FIG. 8A and FIG. 8B depict a flowchart diagram illustrating one embodiment of a method for predictive maintenance using computational models.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “data storage” may include a tangible device that retains and stores data. Such device may include an electronic storage device, a magnetic storage device, an optical storage device, an electromagnetic storage device, a semiconductor storage device, or any suitable combination of the foregoing. A non-exhaustive list of more specific examples of the devices may include a portable computer diskette, a random access memory (RAM), a read-only memory (ROM), an erasable programmable read-only memory (EPROM or flash memory), a static random access memory (SRAM), a hard disk drive (HDD), a solid state drive, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. “Data storage,” in some embodiments, may include a data structure that stores data, and the data structure may be stored on a tangible data storage. Such data storage may include a file system, a database, cloud storage, a data warehouse, a data lake, or other data structures configured to store data.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

As used herein, the term “modify” or “modifying” may include several actions. For example, modifying data may include adding additional data or changing the already-existing data. As used herein, the term “obtain” or “obtaining” may also include several types of actions. For example, obtaining data may include receiving data, generating data, designating data as a logical object, or other actions.

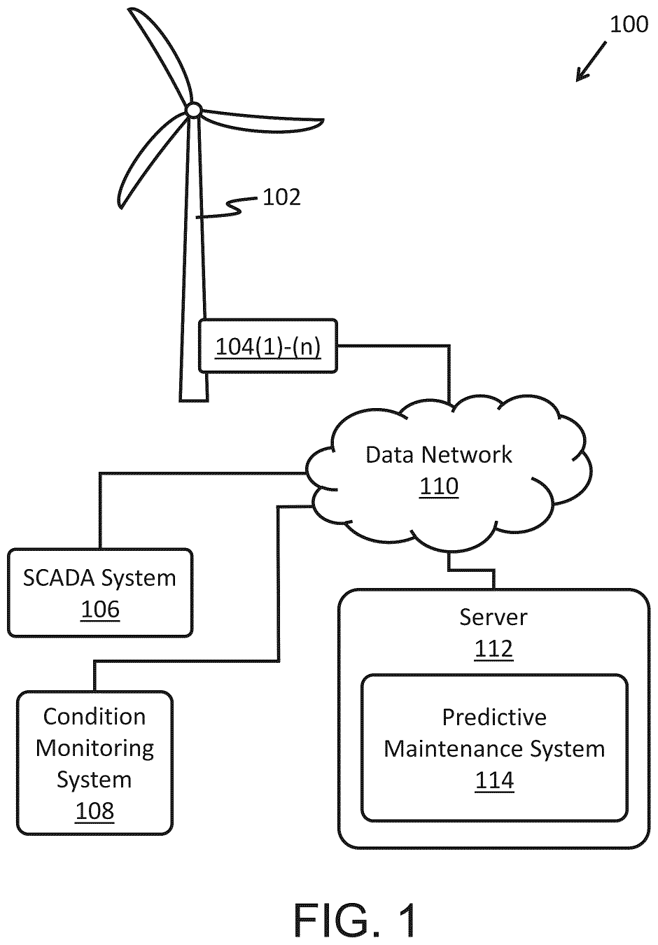

As an overview, FIG. 1 depicts one embodiment of a system 100. The system 100 may include a system for predictive maintenance using computational models. The system 100 may include a wind turbine 102. The wind turbine 102 may include one or more condition detectors 104(1)-(n). A condition detector 104 may monitor a component of the wind turbine 102, a condition parameter of the wind turbine 102, or a condition parameter of a component of the wind turbine 102. A condition detector 104 may send condition data to a supervisory control and data acquisition (SCADA) system 106. The condition detector 104 may send condition data to a condition monitoring system (CMS) 108. One or more other components of the wind turbine 102 (such as sensors disposed in the wind turbine 102) may send data to the SCADA system 106 or CMS 108. The one or more condition detectors 104(1)-(n) may send data to the SCADA system 106 or the CMS 108 via a data network 110.

In some embodiments, a condition detector 104 may be in data communication with the SCADA system 106 or the CMS 108. For example, the condition detector 104 may include a wireless transceiver that may transmit data via radio signals or other wireless means to a router, switch, or other wireless receiver. The condition detector 104 may include a wired connection that connects to a router, switch, or other device. The router, switch, receiver, or other device may be in data communication with the data network 110.

The SCADA system 106 or the CMS 108 may each process their respective received data from the condition detectors 104(1)-(n), sensors of the wind turbine 102, or other devices and may send output data based on the processing to a server 112 via the data network 110. The server 112 may include a predictive maintenance system 114. The predictive maintenance system 114 may receive the data sent from the SCADA system 106, the CMS 108, or other computing devices, and process the received data. In some embodiments, the predictive maintenance system 114 processing the received data may include a machine learning model, artificial intelligence model, a data science model, a statistical model, a physics model, a mechanics model, or some other computational model processing the received data. The predictive maintenance system 114 may generate a health state prediction for the wind turbine 102 or for one or more components of the turbine 102. The health state prediction may include an asset life state or asset insights regarding one or more components of the wind turbine 102.

In one embodiment, the SCADA system 106 may include a system for supervision of machinery and processes. The SCADA system 106 may include one or more computing devices. The computing devices may be in data communication with each other over one or more data networks (e.g., the data network 110). The computing devices may include industrialized input/output modules, supervisory computers, monitoring computers, scheduling computers, or other SCADA components.

In some embodiments, the CMS 108 may include a system for monitoring the condition of one or more machinery components. The CMS 108 may include one or more computing devices, which may be in data communication with each other over one or more data networks (e.g., the data network 110). As one example of a CMS 108, the CMS 108 may include a vibration-based CMS. A condition detector 104 may include a vibration sensor disposed on a gearbox of the wind turbine 102. The condition detector 104 may detect vibration data (e.g., an amount or direction of acceleration, a timestamp of that acceleration, etc.). The condition detector 104 may send the vibration data to the CMS 108. The CMS 108 may record the received acceleration data. The CMS 108 may analyze the acceleration data. Analyzing the acceleration data may include identifying characteristic frequencies of the gearbox, applying a fast Fourier transform (FFT) to the raw vibration signal, and extracting the amplitude of characteristic frequencies. Analyzing the acceleration data may include monitoring the amplitude of the characteristic frequencies over time. Monitoring the amplitude of the characteristic frequencies over time may include (1) a trend analysis of characteristic frequencies, or (2) thresholds for characteristic frequencies. Analyzing the acceleration data may include other damage indication analysis techniques such as band-pass filter (BPF), biosand filter (BSF), ball pass frequency inner (BPFI), ball pass frequency outer (BPFO), or other gear/bearing characteristic frequency amplitude techniques. Analyzing the acceleration data may include harmonics of characteristic frequencies, kurtosis, a noise-to-signal ratio, dampening values of eigen frequencies, cepstrum analysis, or other analysis components.

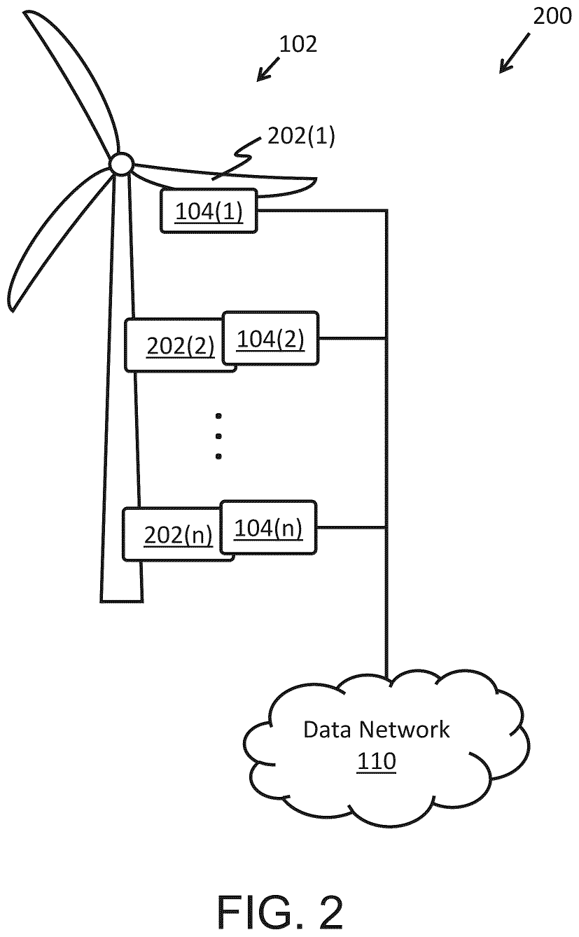

FIG. 2 depicts one embodiment of a system 200. The system 200 may include a subset of the elements of the system 100 of FIG. 1. The system 200 may include the wind turbine 102. The wind turbine 102 may include one or more components 202(1)-(n). One or more of these components 202(1)-(n) may include a corresponding condition detector 104. A condition detector 104 may be in data communication with the data network 110.

In one embodiment, the wind turbine 102 may include a machine that transforms movement caused by wind into electrical energy. The wind turbine 102 may include a gearless wind turbine. The wind turbine 102 may include a horizontal axis turbine, a vertical axis turbine, or another type of turbine. The wind turbine 102 may include one or more components 202(1)-(n). A component 202 may include one or more blades, gearboxes, bearings, shafts, or motors. A component 202 may include an electrical generator, a brake assembly, a pitch system, a yaw system, a transformer, or other components. A component 202 may include a portion of the wind turbine 102 such as the tower, the foundation, the nacelle, or some other portion of the turbine 102.

In one embodiment, a condition detector 104 may include a device configured to monitor a component 202, a condition parameter of the wind turbine 102, or a condition parameter of a component of the wind turbine 102. A condition parameter may include a parameter, characteristic, or other value of the wind turbine 102 or of a component 202 of the wind turbine that may indicate information about a condition of the wind turbine or component 202. A condition parameter may include a temperature, a motion of a component 202, whether a certain element or particle is present, or other parameters.

In one or more embodiments, the condition detector 104 may include a sensor. The condition detector 104 may include a thermocouple, an oil particle counter, a vibration sensor, an ultrasonic sensor, an electrical sensor (e.g., a discharge sensor), a vibro-acoustic sensor, an oil quality sensor, an acoustic emission transducer, a torsional vibration sensor, a fiber optic strain gauge, a thermographic sensor, a shaft torque sensor, a shock pulse sensor, or some other type of sensor or detector. A condition detector 104 may be coupled to, mounted to, connected to, disposed on, or otherwise associated with a component 202 or portion of the wind turbine 102 such that it can detect a condition parameter associated with the component 202 of the wind turbine 102. In some embodiments, a condition detector 104 may monitor multiple components 202, which may be the same type of component 202 or may be different types of components 202. In other embodiments, each condition detector 104 may monitor only a single component 202.

In one or more embodiments, a condition detector 104 may detect a condition parameter of its associated component 202 at a certain time. Data generated by the condition detector 104 may include the detected condition parameter and the timestamp of when the detection occurred. In some embodiments, the data generated may include a time interval and a maximum, minimum, or average value of the condition parameter during that time interval.

For example, a thermocouple or other temperature-sensing condition detector 104 may detect the temperature of its associated component 202 at a certain time. Data generated by the thermocouple may include the detected temperatures and their associated timestamps. In one embodiment, an oil particle counter condition detector 104 may detect the presence of one or more contaminants in the oil of a component 202. Data generated by the oil particle counter may include a number of particles in the oil or a ratio of the particles to oil and their associated timestamps. A vibration sensor condition detector 104 may include a displacement sensor, velocity sensor, or accelerometer and may measure its displacement during a certain time interval, its velocity at a certain time, or its acceleration at a certain time. Data generated by the vibration sensor may include the displacement and its associated time interval, the velocity and its associated timestamp, or the acceleration and its associated timestamp.

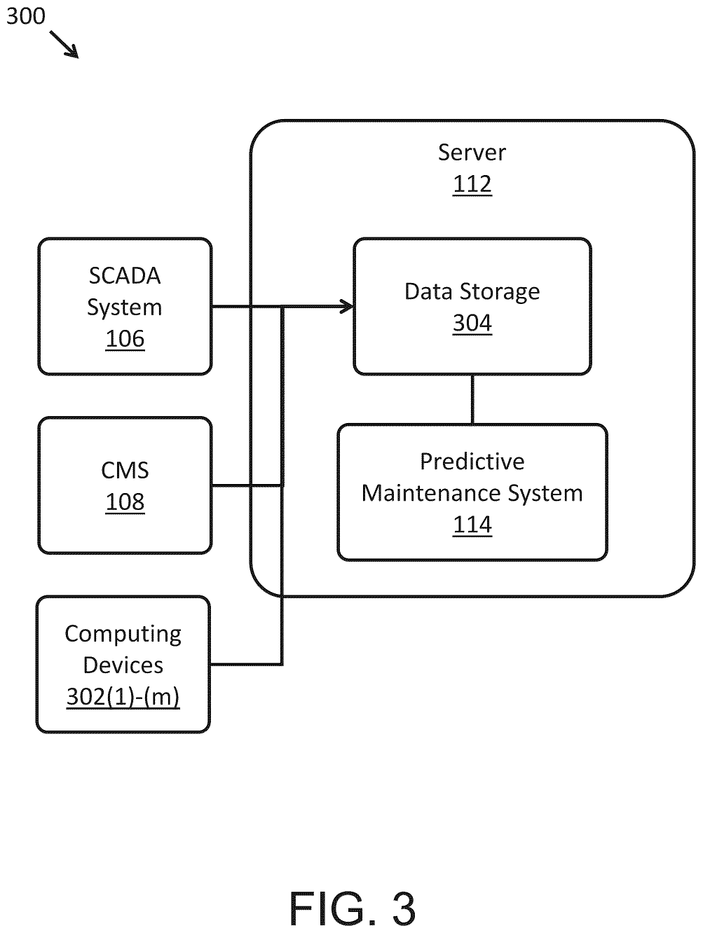

FIG. 3 depicts one embodiment of a system 300. The system 300 may include one or more elements from the system 100 of FIG. 1, such as the SCADA system 106, the CMS 108, the server 112, or the predictive maintenance system 114. The system 300 may include one or more other computing devices 302(1)-(m). Although not shown in FIG. 3, the SCADA system 106, CMS system 108, or the computing devices 302(1)-(m) may be in data communication with the server via the data network 110.

In one embodiment, the server 112 may include a computing device. The server 112 may include a data storage 304. The server 112 may include the predictive maintenance system 114, which may be in data communication with the data storage 304. The data storage 304 may be physically located on the server 112 in some embodiments. In other embodiments, the data storage 304 may be stored on a separate computing device that is in data communication with the server 112 (e.g., via the data network 110). In one embodiment, the predictive maintenance system 114 may include hardware or software. For example, the predictive maintenance system 114 may include a computer program executing on the server 112.

In some embodiments, the computing devices 302(1)-(m) may include a computing device that stores data associated with the wind turbine 102. Such data may include turbine logs that record events associated with the wind turbine 102. Such events may include component 202 failures, alarm data, inspection data, work order data, or other types of events. An entry in the turbine log may include a timestamp of the when the event occurred, the one or more components 202(1)-(n) associated with the event, or a description of the event. A computing device 302 device may store turbine configuration data. Turbine configuration data may include data indicating one or more features, characteristics, or parameters of a component 202 of the turbine 102. For example, turbine configuration data may include data indicating a serial number, model number, or manufacturer of the component 202; size or shape information about the component 202; or other features, characteristics, or parameters of the component 202. The one or more computing devices 302(1)-(m) may send at least a portion of such data that they store to the server 112.

In one embodiment, the data storage 304 may store data received from the SCADA system 106, the CMS 108, or the one or more computing devices 302(1)-(m). In one embodiment, the SCADA system 106 or the CMS 108 may send data to the predictive maintenance module 114. The data received from the SCADA system 106 may include data based on an analysis or processing that the SCADA system 106 performed using data received from the condition detector 104 or other components of the wind turbine 102. The data received from the CMS 108 may include data based on an analysis or processing that the CMS 108 performed using data received from the condition detector 104.

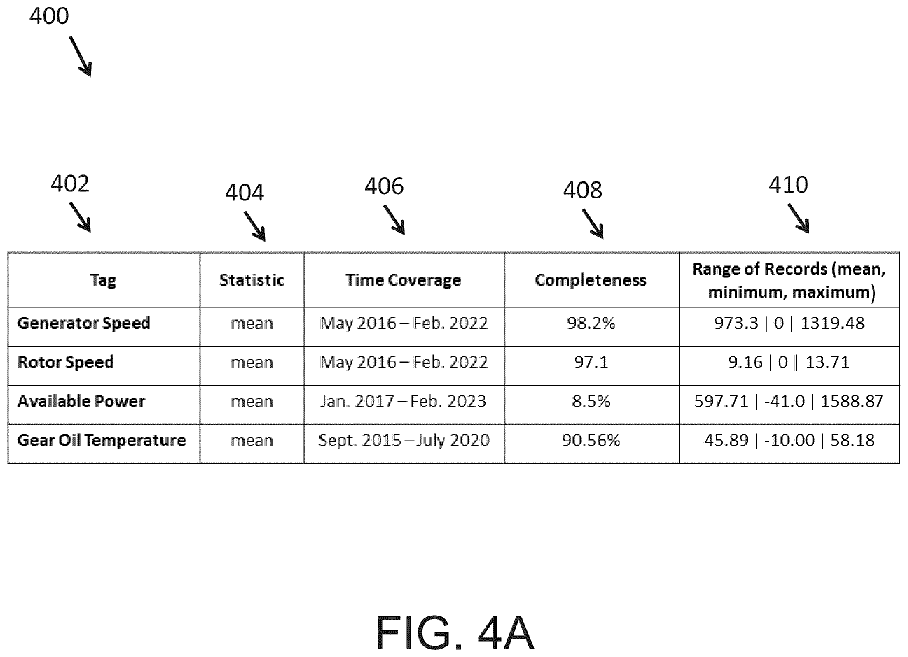

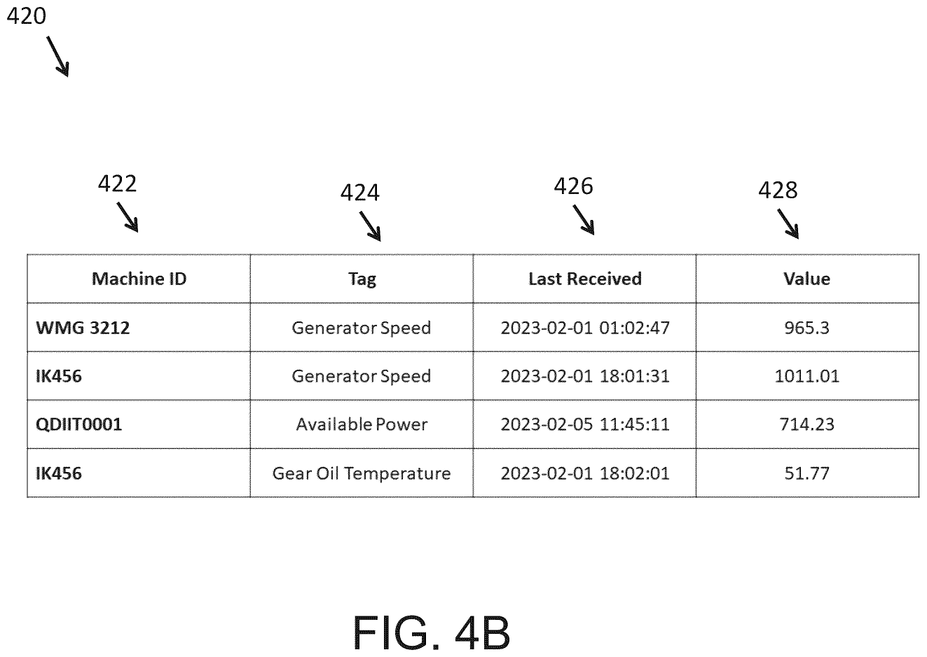

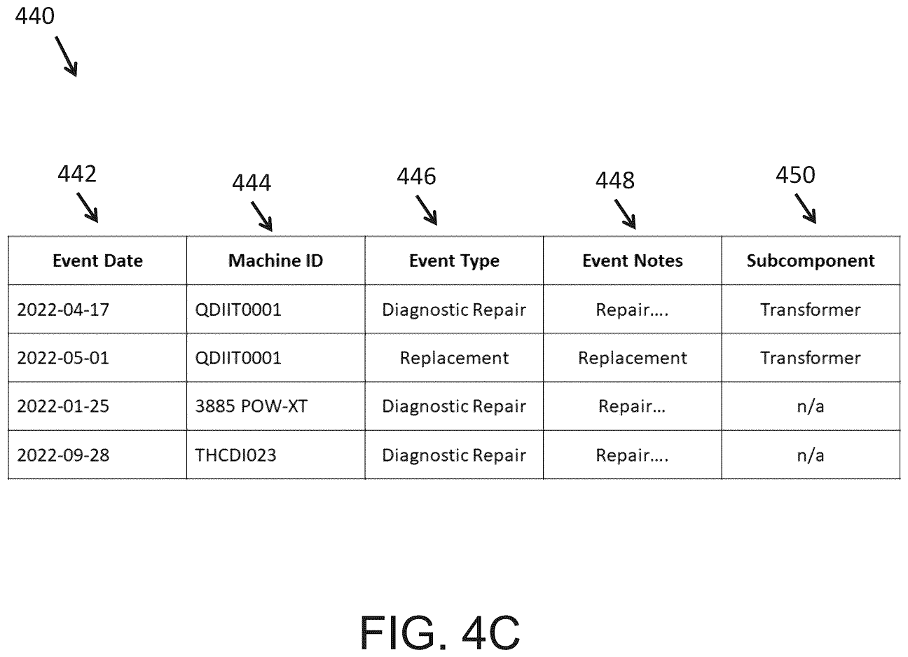

FIG. 4A depicts one embodiment of data 400 received from the SCADA system 106. Each row in the table of data 400 may correspond to a condition parameter. The condition parameter may be associated with a specific component 202 or with multiple components 202. The data 400 may include a tag 402. The tag 402 may include the condition parameter of the row. The condition parameter may include a condition parameter associated with a specific component 202. The condition parameter may include a condition parameter associated with multiple components 202, which may be of the same component type. The data 400 may include a statistic 404. The statistic may indicate what statistical measure is associated with the tag 402. The statistic 404 may include a mean, median, mode, standard distribution, minimum value, maximum value, or some other statistical measure type. The data 400 may include a time coverage 406. The time coverage 406 may include a time period over which condition parameter data was collected from a certain component 202. The data 400 may include a completeness 408. The completeness 408 may include a value that may indicate the completeness of data collection regarding the condition parameter over the time coverage 406. For example, as depicted in FIG. 4A, a completeness 408 value of 98.2% may indicate that data from a sensor was able to measure the associated condition parameter 98.2% of the time over the time coverage 406 of May 2016 to February 2022. The data 400 may include a range of records 410. The range of records 410 may include one or more statistical measures regarding the condition parameter indicated by the tag 402. The one or more statistical measures may include a mean, a minimum value, a maximum value, or some other type of statistical measure. The range of records 410 may include values for the time period indicated in the time coverage 406. For example, as shown in FIG. 4A, the generator speed of a component 202 may have been measured over the time period of May 2106 to February 2022, and during that time period, the mean generator speed may have been 973.3, the minimum generator speed may have been 0, and the maximum generator speed may have been 1,319.48. The data 400 may include other types of data collected by a SCADA system 106.

FIG. 4B depicts one embodiment of data 420 received from the CMS 108. Each row of the data 420 may correspond to a component 202 or device of the wind turbine 102. The data 420 may include a machine ID 422. The machine ID 422 may include data that uniquely identifies the component 202, a machine or device that include a component 202, or some other machine for the row of the table. The data 420 may include a tag 424. The tag 424 may be similar to the tag 402 of the data 400 of FIG. 4A. The data 420 may include a last received timestamp 426. The last received timestamp 426 may include the timestamp of when the value of the tag 424 was measured by a sensor, received at the CMS 108, received by the server 112, or received by the predictive maintenance system 114. The data 420 may include a value 428. The value 428 may include the value of the tag 424 that was received at the last received timestamp 426. As an example, in FIG. 4B, the generator speed of a component 202 identified by the machine ID 422 of “IK456” may have been measured by a sensor, and the sensor may have measured the value 1011.01. The sensor may have sent the measurement data to the CMS 108, which may have sent the measurement to the server 112. The server 112 may have received the measurement and may have included the timestamp of when the measurement was received as the last received timestamp 426. The data 420 may include other types of data collected by a CMS 108.

FIG. 4C depicts one embodiment of data 440 received from the one or more computing devices 302(1)-(m). The data 440 may include log data. The log data may include data indicating a diagnosis, repair, or other maintenance event occurred in relation to the wind turbine 102 or a component 202. Each row of the data 440 may correspond to a log event. The data 440 may include an event date 442. The event date 442 may include the date or timestamp of when the log event occurred. The data 440 may include a machine ID 444. The machine ID 444 may be similar to the machine ID 422 of the data 420 of FIG. 4B. The data 440 may include an event type 446. The event type 446 may include the type of the log event, which may include one or more of a repair, a replacement, a diagnosis, or some other event type. The data 440 may include event notes 448. The event notes 448 may include notes describing the log event. The event notes 448 may include text, machine-readable text, one or more images, or other data describing the log event. The data 440 may include a subcomponent 450. The subcomponent 450 may include data indicating the subcomponent of the component 202 or device identified by the machine ID 444 that underwent the log event. For example, if the machine ID 444 indicates the wind turbine 102, a subcomponent 450 may include a component 202 of the wind turbine 102. The data 440 may include other data collected by one or more computing devices 301(1)-(m).

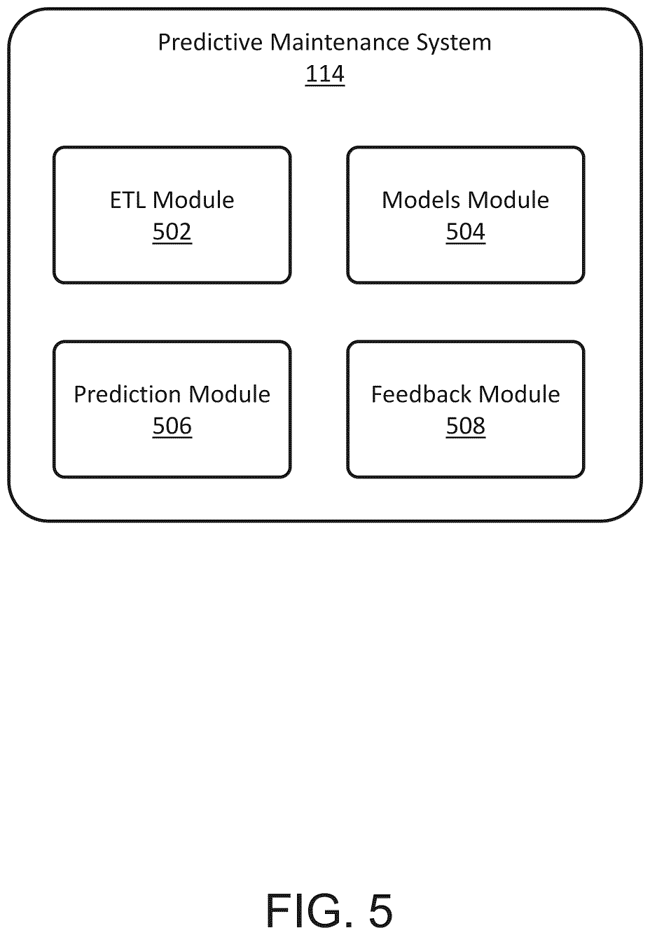

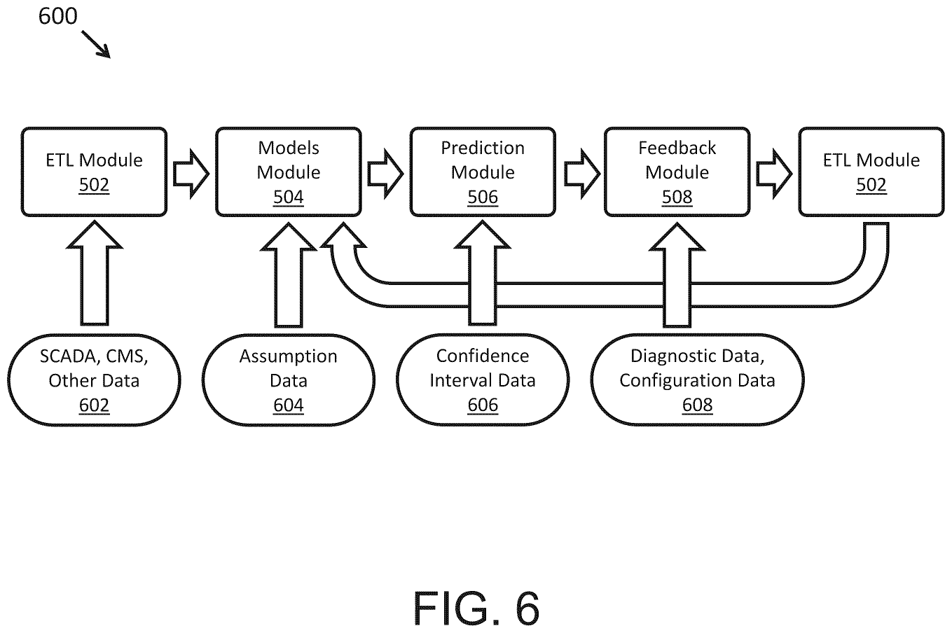

FIG. 5 depicts one embodiment of the predictive maintenance system 114. In one or more embodiments, the predictive maintenance system 114 may use the data received from the SCADA system 106, the CMS 108, or the one or more computing devices 302(1)-(m) to generate a health state prediction for the wind turbine 102 or for one or more components 202(1)-(n) of the wind turbine 102. The health state prediction may include an asset life state of a component 202 of the wind turbine 102, one or more asset insights about a component 202, or other component 202-related information. The predictive maintenance system 114 may include an extract, transform, and load (ETL) module 502, a models module 504, a prediction module 506, or a feedback module 508. FIG. 6 depicts one embodiment of a data flow 600. The data flow 600 may include the modules 502-508 of the predictive maintenance system 114. The data flow 600 may include various types of data that are received by the modules 502-508. The data flow 600 may indicate a flow of data from one module 502-508 to another.

As an overview of the predictive maintenance system 114 and system 600, the ETL module 502 may retrieve data from the data storage 304, which may include data from the SCADA system 106, the CMS 108, or the one or more computing devices 302(1)-(m) (collectively, the “SCADA, CMS, and other data 602”). The ETL module 502 may transform the SCADA, CMS, and other data 602 into a format that is usable by one or more other modules 504-508 of the predictive maintenance system 114 and store the transformed data in the data storage 304. This transformed data is referred to herein as “model input data.”

In some embodiments, the ETL module 502 may extract SCADA, CMS, and other data 602 from the data storage 304, process the data 602 to transform the data into a format that is usable or expected by other modules 504-508 of the predictive maintenance system 114, and store the transformed data (the model input data) in the data storage 304. Transforming the data 602 may include adding metadata to the data 602, tagging the data 602 with further data, or performing other data transformation operations. In one embodiment, the ETL module 502 may determine a data coverage or data sufficiency of the SCADA, CMS, and other data 602 or the model input data.

In one embodiment, the ETL module 502 may determine data coverage of the data 602 using one or more factors. The factors may include data freshness. Data freshness may be based on an analysis of the age of the data 602. In some embodiments, newer data may be more valuable than older data, thus, new data 602 may indicate better coverage. Another factor may include data consistency. Data consistency may be based on whether the data 602 is consistent with other data from similar sources or associated with similar components 202. For example, if the data 602 comes from a condition detector 104 associated with a certain type of component 202, determining whether the data 602 includes similar values as other data received from a condition detector 104 associated with a similar type of component 202 indicates whether the data 602 is consistent. Another factor may include data integrity. Data integrity may be based on whether the data 602 has not been corrupted (e.g., due to errors in a condition detector 104, transmission of the data 602, etc.).

In some embodiments, the ETL module 502 may determine a data coverage for the data 602 based on whether the amount of quality data, as determined by the data coverage, exceeds a pre-determined threshold. In certain embodiments, a model of the models module 504 may only be able to use the SCADA, CMS, and other data 602 if the data 602 coverage exceeds a threshold associated with that model.

The models module 504 may include one or more computational models (e.g., machine learning models, statistical analysis models, etc.). The models module 504 may receive the model input data and assumption data 604 and use this data as input to one or more models to make one or more predictions or analyses regarding one or more of the components 202 of the wind turbine 102. A model of the models module 504 may process at least a portion of the model input data and generate a prediction regarding a component 202 of the wind turbine 102 based on that data. In one embodiment, the models module 504 may retrieve the model input data from the data storage 304. In certain embodiments, the models module 504 may receive the model input data from the ETL module 502.

In one or more embodiments, the models module 504 may include one or more computational models. A model may include a machine learning model, an artificial intelligence model, a data science model, a statistical model, a physics model, or some other computational model. In one embodiment, the models of the models module 504 may include a power curve model, an asset underperformance model, a geospatial risk indices model, a pitch imbalance model, a yaw misalignment model, a gearbox normal behavior model, a generator normal behavior model, a survival analysis model, a physics-driven damage classification model, a generator electrical short model, a transformer model, oil sensor model, raw vibration data model, fault or alarm model, or some other type of model. In some embodiments, a model of the models module 504 may include a pre-trained model. The model may be pre-trained in the sense that the model has already undergone a training process with one or more training datasets and validation datasets. In some embodiments, the model may not be pre-trained. In certain embodiments, for machine learning models, generating the model may include (1) automating machine learning feature extraction, (2) creating a training dataset and a validation dataset, (3) training the model, and (4) iteratively repeating steps (2) and (3) until the model achieves a satisfactory prediction quality. For data science models, generating the model may include automating extraction of damage indicators.

In some embodiments, the models of the models module 504 may include a fault analytics model. The fault analytics model may retrieve alarm data associated with one or more components 202(1)-(n) from the model input data. The fault analytics model may use this data as input and detect damage or other condition information regarding the one or more components 202(1)-(n). The fault analytics model can be expanded to warnings that systems or subsystems exhibit prior to alarm trigger. Furthermore, the alarm data can support early warning criteria before catastrophic failure of components 202(1)-(n). In addition, fault analytics models can also be used to detect cause-effect relationships among various alarms and identify primary and secondary alarms that are responsible for a machine problem or failure.

In one or more embodiments, the models of the models module 504 may include a temperature damage model. The temperature damage model may retrieve temperature data associated with a component 202 from the model input data. The temperature damage model may use this data as input and detect if the component's 202 temperature indicates damage or provides other information about the state or condition of the component 202. During the model training phase, the thresholds are calibrated and are then applied to the component data. The component or sub-component behavior is monitored over time with respect to these thresholds to represent damage progression and to identify the damage severity. As an example, when a temperature deviation occurs and the model represents an anomaly, a specific operation can be triggered to verify the condition with a focused inspection of the component 202.

In some embodiments, the models module 504 may receive the model input data and assumption data 604. The assumption data 604 may include data indicating assumptions about the component 202. Such assumptions may include a threshold or an upper or lower bound. For example, the component 202 may include a threshold temperature, and if the component 202 experiences a temperature above such threshold, it may indicate that the component 202 is damaged or otherwise not functioning properly. The assumption data 604 may include this temperature threshold. In another example, the component 202 may include bounds on vibration, and the component 202 experiencing vibrations outside of these bounds may indicate the component 202 is damaged or otherwise not functioning properly. The assumption data 604 may include such vibration bounds. The assumption data 604 may include other assumption data such as bounds or thresholds associated with other characteristics or configurations of the component 202. In some embodiments, the assumption data 604 may be based on the specific model or manufacturer of the component 202. For example, a gearbox manufactured by Manufacturer A may include different vibration bounds that a gearbox manufactured by Manufacturer B. In some embodiments, the assumption data 604 may affect how a model generates a prediction based on processing the model input data.

The prediction module 506 may receive at least a portion of the predictions or analyses generated by the models module 504. The prediction module 506 may also receive confidence interval data 606. The prediction module 506 may use the confidence interval data 606 to further refine the predictions or generate other component 202 predictions.

The feedback module 508 may receive data from the SCADA system 106, the CMS 108, or another computing device 302 that may indicate whether a prediction of a model of the models module 504, or a prediction of the prediction module 506 was correct (referred to herein as “diagnostic and configuration data 608”).

The ETL module 502 may receive the output of the feedback module 508. The ETL module 502 may also receive additional SCADA, CMS, and other data 602. Based on the output of the feedback module 508 or the additional SCADA, CMS, and other data 602, the models module 504 may perform one or more remedial actions to improve the accuracy of its models' predictions. For example, the one or more remedial actions may include rerunning the models on the original model input data and additional model input data generated from the additional SCADA, CMS, and other data 602, retraining the models, or other actions.

In one embodiment, a remedial action may include rerunning the models module 504 with the ETL module 502 receiving additional SCADA, CMS, and other data 602. The additional SCADA, CMS, and other data 602 may include SCADA, CMS, and other data 602 that is different than the SCADA, CMS, and other data 602 initially received by the ETL module 502. The additional SCADA, CMS, and other data 602 may include data corresponding to one or more time periods that occur at least partially after one or more time periods corresponding to the initial SCADA, CMS, and other data 602. Rerunning the models module 504 may include generating additional model input data based on the additional SCADA, CMS, and other data 602. Rerunning the models module 504 may include using the additional model input data as input to the one or more models to generate an updated component analysis. Rerunning the models module 504 may include using the initial model input data and the additional model input data as input to the one or more models to generate the updated component analysis.

In some embodiments, a remedial action may include retraining one or more models of the models module 504. In one embodiment, retraining the one or more models may include the ETL module 502 receiving additional SCADA, CMS, and other data 602. The ETL module 502 may then modify the additional SCADA, CMS, and other data 602 into a training dataset or a validation dataset. The ETL module 502 may then provide the training dataset to the models module 504, which may then train the one or more models on the training dataset and validate the models on the validation dataset.

In one embodiment, retraining the one or more models may include the ETL module 502 modifying the initial SCADA, CMS, and other data 602 or the initial model input data using the diagnostic and configuration data 608 to generate a training dataset. Initially, the initial SCADA, CMS, and other data 602 or the initial model input data may not be usable as training data since the initial SCADA, CMS, and other data 602 or initial model input data may not include an outcome or answer. However, the diagnostic and configuration data 608 may provide such outcomes or answers for the initial SCADA, CMS, and other data 602 or the initial model input data. Modifying the initial SCADA, CMS, and other data 602 or the initial model input data using the diagnostic and configuration data 608 may include determining which diagnostic and configuration data 608 corresponds with which initial SCADA, CMS, and other data 602 or initial model input data to generate a training dataset. Retraining the one or more models may include the models module 504 receiving the training dataset and training the models on the training dataset.

In one embodiment, the feedback module 508, ETL module 502, or some other module 502-508 of the predictive maintenance system 114 may determine whether to rerun the models module 504 using additional data or whether to retrain the models of the models module 504 using additional data. In some embodiments, the predictive maintenance system 114 may rerun the models module 504 each time the predictive maintenance system receives the diagnostic and configuration data 608. The predictive maintenance system 114 may rerun the models module 504 each time the predictive maintenance system receives additional SCADA, CMS, and other data 602. In some embodiments, the predictive maintenance system 114 may retrain one or more models of the models module 504 each time the predictive maintenance system receives the diagnostic and configuration data 608. The predictive maintenance system 114 may retrain one or more models of the models module 504 in response to user input indicating to retrain the one or more models.

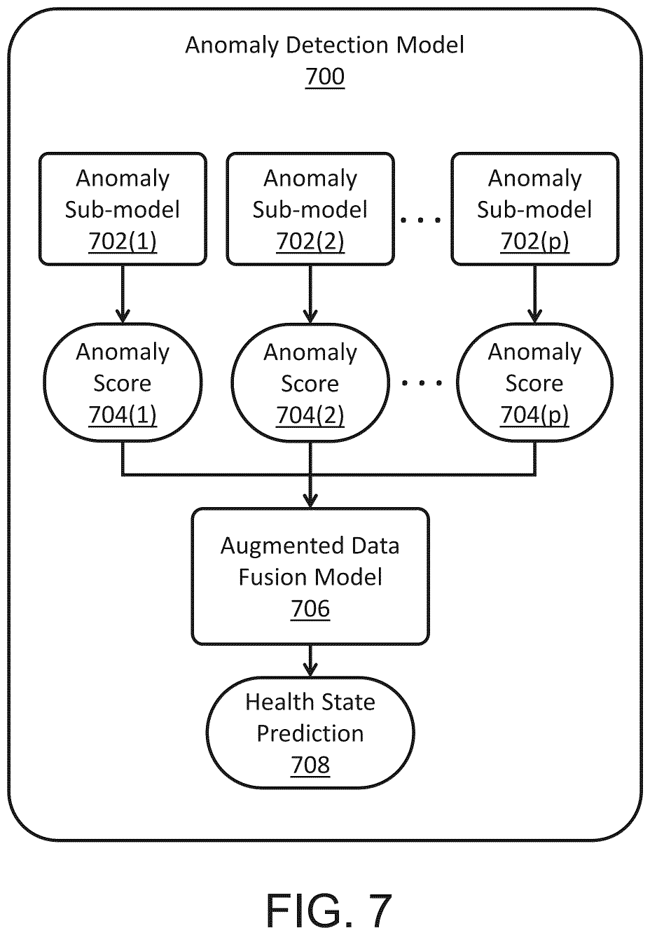

FIG. 7 depicts one embodiment of an anomaly detection model 700. The anomaly detection model 700 may include multiple anomaly sub-models 702(1)-(p). One or more anomaly sub-models 702(1)-(p) may each generate an anomaly score 704(1)-(p). The anomaly detection model 700 may include an augmented data fusion model 706. The augmented data fusion model 706 may receive the one or more anomaly scores 704(1)-(p) as input and may generate a health state prediction 708.

In some embodiments, the models module 504 may include the anomaly detection model 700. The anomaly detection model 700 may identify abnormal behavior in a component 202. In some embodiments, the anomaly detection model 700 may be configured to process the model input data associated with a specific type of component 202, or the anomaly detection model 700 may include an anomaly detection model compatible with multiple types of components 202.

In one embodiment, the anomaly detection model 700 may include a prognostic model that may identify anomalies in model input data. The anomaly detection model 700 may establish a normal behavior for the monitored component 202. Establishing normal behavior may include comparing the model input data with training data from other similar components 202. The anomaly detection model 700 may identify abnormal behavior by identifying deviations from the normal behavior in the model input data.

In some embodiments, the anomaly detection model 700 may identify one or more damage indicators in the model input data. A damage indicator may include an individual measurable property or characteristic of a phenomenon that indicates that damage is present in the associated component 202. Identifying a damage indicator may include identifying a deviation from normal operating conditional behavior or identifying an anomaly in the model input data.

In some embodiments, using the anomaly detection model 700 to make a prediction may include using the features or damage indicators of the model input data as input. As an example, for a vibration-based CMS 108, the anomaly detection model 700 may extract the following features from the CMS data: gear or bearing characteristic frequency amplitude, harmonics of characteristic frequencies, kurtosis, a noise-to-signal ratio, damping values characteristic frequencies, or wavelet analysis. Other features may include mechanical resonance (e.g., excited amplitude in various operating states, frequency, damping, or mode shape). As another example, the anomaly detection model 700 may extract particle-count data from model input data. A particle count CMS 108 may measure, at a fixed frequency, the number of particles in oil or grease of a gearbox or bearing. The number of particles may be binned by size. The CMS 108 may analyze by particle size class, or in the case where a certain damage mode can be associated with a certain particle size, the determination of damage modes. Particle count can be used to measure the progression of damage in a component 202. By accumulating the particle count, monitoring the damage progress is possible.

In some embodiments, the anomaly detection model 700 may assess the operating state of the wind turbine 102. The anomaly detection model 700 may automatically correlate model input data based on data 602 from the SCADA system 106 (such as the operating state of the wind turbine 102 or the component 202 with which the condition detector 104 is associated with) with model input data based on the data 602 received from the CMS 108. Thus, normal behavior recorded by the CMS 108 may be operation state-specific. The anomaly detection model 700 may detect abnormal behavior if it is abnormal for the current values of SCADA parameters. As an example, the vibration behavior of a gearbox might change in response to applied torque. The anomaly detection model 700 correlating SCADA data (received from the SCADA system 106) with the vibration data (received from the CMS 108) may allow the anomaly detection model 700 to detect this dependency.

In some embodiments, an anomaly sub-model 702 may include a machine learning model, an artificial intelligence model, a data science model, a statistical model, or another type of computational model. The augmented data fusion model 706 may also include a computational model. The augmented data fusion model 706 may include a supervised machine learning model that has been trained from labeled data. In some embodiments, training the augmented data fusion model 706 may include (1) running the anomaly sub-models 702(1)-(p) regularly over a period of time (e.g., once a month) so that the anomaly sub-models 702(1)-(p) may generate continuous anomaly scores 704(1)-(p) associated with multiple components 202(1)-(n) of the wind turbine 102. Training the augmented data fusion model 706 may include (2) creating labeled data (e.g., using inspection reports or component exchanges or correlate data with the anomaly scores 704(1)-(p) from the anomaly sub-models 702(1)-(p)). Training the augmented data fusion model 706 may include (3) training the model 706 to determine a health state from the anomaly scores 704(1)-(p) and assessing the quality of the created machine learning model 706 with a validation set of the labeled data. Training the augmented data fusion model 706 may include iterating over steps (2) and (3) until the quality of the prediction of the model 706 is satisfactory.

In some embodiments, the multiple anomaly sub-models 702(1)-(p) may each receive model input data and generate an anomaly score 704. The multiple anomaly scores 704(1)-(p) may be used as input to the augmented data fusion model 706. The augmented data fusion model 706 may process the anomaly scores 704(1)-(p) to produce a health state prediction 708. In some embodiments, a first anomaly sub-model 702(1) may receive only SCADA data from the model input data, and one or more other anomaly sub-models 702(2)-(p) may each receive only CMS data from different CMSs 108 in the model input data. In this manner, each anomaly sub-model 702 may only receive data from either a SCADA system 106 or a CMS 108 associated with a component 202. The augmented data fusion model 706 may use the anomaly scores 704(1)-(p) from the different anomaly sub-models 702(1)-(p) to determine a health state prediction 708 for the wind turbine 102 generally.

In some embodiments, in response to processing the model input data, a model of the models module 504 may generate a component analysis. A component analysis may include predictions regarding one or more components 202 of the wind turbine 102. In some embodiments, the predictions may include an estimated time until a component 202 fails. The component analysis may include an indication that the component 202 is underperforming or malfunctioning. The component analysis may include an indication that a component 202 is damaged. The component analysis may include a mean time of observable damage of a component 202. The component analysis may include the health state prediction 708 of the anomaly detection model 700. In one embodiment, the component analysis may include a statistical analysis regarding one or more components 202. The component analysis may include other data regarding a state of a component 202.

In some embodiments, multiple models of the models module 504 may form an ensemble. The ensemble of models may generate a component analysis.

In one embodiment, the models module 504 may send its component analysis to the prediction module 506. The prediction module 506 may receive the confidence interval data 606. The prediction module 506 may receive the component analysis from the models module 504 and evaluate it. The prediction module 506 may evaluate the component analysis using the confidence interval data 606.

In one embodiment, the confidence interval data 606 may include data indicating a reliability of the component analysis generated by the models module 504. In one or more embodiments, the confidence interval data 606 may include data indicating a confidence that a model of the models module 504 has in its own prediction or component analysis. The confidence interval data 606 may be specific to a certain computational model of the models module 504. In some embodiments, at least a portion of the confidence interval data 606 may be inputted by a user of the predictive maintenance system 114. For example, the predictive maintenance system 114 may include a user interface, and the user interface may display the component analysis generated by the models module 504. The user may review the component analysis and use an input device (e.g., mouse, keyboard, touchscreen, or other input device) to input data indicating a confidence the user has in the component analysis to be used in generating the confidence interval data 606. In some embodiments, the models module 504 or prediction module 506 may generate the confidence interval data 606 based on one or more factors of the data coverage (e.g., data freshness, data integrity, data consistency, etc.). In some embodiments, multiple confidence intervals, each regarding a different computational model of the models module 504 may be evaluated by the prediction module 506 to generate an overall confidence in the component analysis.

In one embodiment, the prediction module 506 may generate a second component analysis. The second component analysis may be based on the component analysis received from the models module 504 and the confidence interval data 606. The second component analysis may include a refined version of the component analysis from the models module 504.

The feedback module 508 may receive the second component analysis from the prediction module 506. The feedback module 508 may receive the diagnostic and configuration data 608. The feedback module 508 may determine whether the second component analysis from the prediction module 506 is compatible with the diagnostic and configuration data 608. The second component analysis may be compatible with the diagnostic and configuration data 608 in response to the second component analysis being accurate in light of the diagnostic and configuration data 608. The second component analysis may be incompatible with the diagnostic and configuration data 608 in response to the second component analysis being inaccurate in light of the diagnostic and configuration data 608.

In one embodiment, the diagnostic and configuration data 608 may include data describing a diagnostic event. The data describing a diagnostic event may include a timestamp of the event, an identification of the one or more components 202 associated with the event, and information about the event. Such data may include borescope data or other visual data, vibration data from the CMS 108, oil sensor data, or some other type of diagnostic data. In some embodiments, the diagnostic and configuration data 608 may include unstructured data. The predictive maintenance system 114 or some other computing device may format the unstructured data. In one or more embodiments, the diagnostic and configuration data 608 may include data indicating a change in the turbine 102 between the inputting of the SCADA, CMS, and other data 602 and the receipt or processing of the diagnostic and configuration data 608. As an example, a failure of a component 202 of the turbine 102 may have resulted in a replacement of that component 202. The replacement component may be of a different type (e.g., a different model or manufacturer from the original component). Thus, in some embodiments, the diagnostic and configuration data 608 may include data indicating a change in a component that is generally static in nature.

In one or more embodiments, a prediction of the second component analysis being accurate may include the component analysis indicating that a certain component 202 failed at a calculated time or during a calculated time period and the diagnostic and configuration data 608 indicating that the component 202 failed within a threshold period from the calculated time or during the calculated time period. This may be referred to as a “true positive.” The prediction being accurate may include the component analysis indicating that a certain component 202 will not fail before a calculated time and the diagnostic and configuration data 608 indicating that the component 202 did not fail prior to the calculated time (a “true negative”). The prediction being inaccurate may include the component analysis indicating that a certain component 202 will fail at a calculated time or during a calculated time period and the diagnostic and configuration data 608 indicating that the component 202 did not fail within a threshold period from the calculated time or during the calculated time period (a “false positive”). The prediction being inaccurate may include the component analysis indicating that a certain component 202 will fail before a calculated time and the diagnostic and configuration data 608 indicating that the component 202 did not fail prior to the calculated time (a “false negative”).

In some embodiments, the second component analysis being compatible may include an indication that a component 202 is damaged or underperforming and the diagnostic and configuration data 608 confirming the indication. The second component analysis being incompatible may include an indication that a component 202 is damaged or underperforming and the diagnostic and configuration data 608 disproving the indication. In certain embodiments, the feedback module 508 may determine the accuracy or inaccuracy of a second component analysis in other ways.

In some embodiments, in response to the second component analysis being incompatible with the diagnostic and configuration data 608, the feedback module 508 may perform one or more remedial actions. For instance, a remedial action may include rerunning the models module 504 on additional data or retraining the models, as described above.

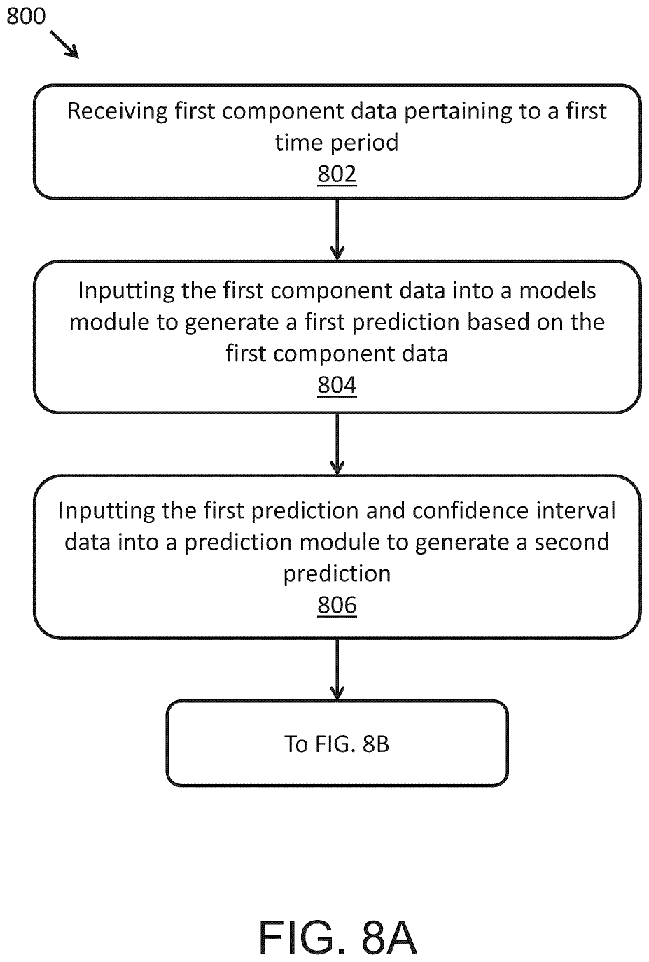

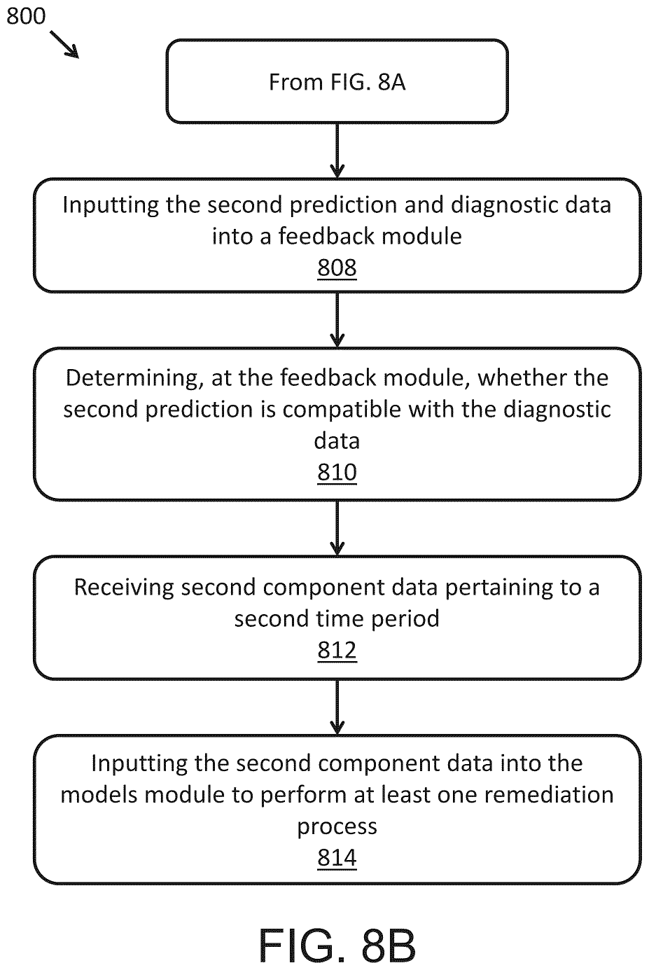

FIGS. 8A-8B depict one embodiment of a method 800. The method 800 may include a method for predictive maintenance using computational models. The method 800 may include one or more steps or actions performed by one or more components of the predictive maintenance system 114 as described herein.

In one embodiment, the method 800 may include receiving first component data pertaining to a first time period (step 802). The first component data may include data from the SCADA system 106 or the CMS 108. The first component data may include data generated from a sensor (such as a condition detector 104) associated with a component 202. The method 800 may include inputting the first component data into the models module 504 of the predictive maintenance system 114 to generate a first prediction based on the first component data (step 804). The models module 504 may include one or more computational models. The method 800 may include inputting the first prediction and confidence interval data 606 into a prediction module 506 to generate a second prediction (step 806).

The method 800 may include inputting the second prediction and diagnostic data 608 into a feedback module 508 (step 808). The diagnostic data 608 may include data indicating one or more diagnostic events occurring at the wind turbine 102. The method 800 may include determining, at the feedback module 508, whether the second prediction is compatible with the diagnostic data 608 (step 810). In response to the second prediction not being compatible with the diagnostic data 608, the method may include receiving second component data 602 pertaining to a second time period (step 812). The second time period may occur at least partially after the first time period. The method 800 may include inputting the second component data 602 into the models module 504 to perform at least one remediation process (step 814).

Although the present disclosure has discussed the systems and methods in relation to a wind turbine 102, the systems and methods disclosed herein are applicable to other types of machinery. The EV industry has a direct relationship to a wind turbine, processing the telemetry data from the individual vehicles in an identical manner as SCADA data to a wind turbine. Smart manufacturing lines are also candidates for the similar data relationship from asset to data. As a result, the predictive maintenance process of the present disclosure can be applied to other technologies and/or industries in renewable energy, aerospace, and manufacturing, as non-limiting examples.

The systems and methods disclosed herein have many advantages over prior condition monitoring efforts. For example, the augmented data fusion model 706 may be agnostic of the type of anomaly detector (anomaly sub-model 202(1)-(p)) and the methods used to create the anomaly score 204. The model 706 may be agnostic to the number of anomaly detectors 202. The model 706 may accept input from anomaly detectors 202 based on SCADA data or CMS data. Furthermore, the systems and methods disclosed herein may provide additional information for asset health state assessment in a single system instead of several parallel systems that may give contradicting recommendations. The systems and method disclosed herein may combine advantages of various CMSs 108 and eliminate disadvantages related to using multiple CMSs 108. Lastly, the systems and methods of the disclosure provide for the opportunity to locate the source of an anomaly because the systems and methods may utilize multiple sensors associated with a piece of machinery.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions, which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single dataset or may be distributed over different locations including over different storage devices, and may exist, at least partially, merely as electronic signals on a system or network. Where a module or portions of a module are implemented in software, the program code may be stored and/or propagated on one or more computer-readable media.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods, and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present disclosure of a new and useful Systems and Methods for Predictive Maintenance Using Computational Models, it is not intended that such references be construed as limitations upon the scope of this disclosure.

What is claimed is:

1. A system for predictive maintenance using computational models, comprising:
an extract, transform, and load (ETL) module configured to receive first component data pertaining to a first time period, wherein
the first component data includes data from at least one of a supervisory control and data acquisition (SCADA) system or a condition monitoring system (CMS), and
the first component data includes data generated from a sensor associated with a component of a machine;
a models module configured to
receive, as input, the first component data from the ETL module, and
generate, using one or more computational models, a first prediction based on the first component data;
a prediction module configured to
receive the first prediction from the models module, and
generate a second prediction based on the first prediction and confidence interval data received by the prediction module; and
a feedback module configured to
receive the second prediction from the prediction module,
receive diagnostic data, wherein the diagnostic data includes data indicating one or more diagnostic events occurring at the machine, and
determine whether the second prediction is compatible with the diagnostic data;
wherein
in response to the second prediction not being compatible with the diagnostic data, the ETL module is further configured to receive second component data pertaining to a second time period, wherein the second time period occurs at least partially after the first time period, and
the models module is further configured to perform at least one remediation process based on the second component data.

2. The system of claim 1, wherein the machine comprises a wind turbine.

3. The system of claim 1, wherein a computational model of the one or more models of the models module comprises a machine learning model.

4. The system of claim 1, wherein a computational model of the one or more models of the models module comprises a statistical model.

5. The system of claim 1, wherein a computational model of the one or more models of the models module comprises a physics-based computational model.

6. The system of claim 1, wherein:
a computational model of the one or more models of the models module comprises an anomaly detection model;
the anomaly detection model includes a plurality of anomaly sub-models and an augmented data fusion model, wherein each anomaly sub-model of the plurality of anomaly sub-models and the augmented data fusion model include a machine learning model;
each anomaly sub-model of the plurality of anomaly sub-models is configured to generate an anomaly score based on the first component data to produce a plurality of anomaly scores; and
the augmented data fusion model is configured to receive the plurality of anomaly scores from the plurality of anomaly sub-models and generate a health state prediction based on the plurality of anomaly scores.

7. The system of claim 6, wherein the first prediction comprises the health state prediction generated by the augmented data fusion model.

8. The system of claim 1, wherein the data from the SCADA system comprises one or more of a condition parameter of the component or a value of the condition parameter.

9. The system of claim 1, wherein the data from the CMS comprises one or more of a condition parameter of the component or a value of the condition parameter.

10. The system of claim 1, wherein the first component data further comprises one or more of data identifying the component or data indicating a diagnostic event associated with the component.

11. A computer-implemented method for predictive maintenance using computational models, comprising:
receiving, by a computing device, first component data pertaining to a first time period, wherein the first component data includes data from at least one of a SCADA system or a CMS, and the first component data includes data generated from a sensor associated with a component of a machine;
inputting, by the computing device, the first component data into a models module of a predictive maintenance system to generate a first prediction based on the first component data, wherein the models module includes one or more computational models;
inputting, by the computing device, confidence interval data and the first prediction into a prediction module to generate a second prediction;
inputting, by the computing device, diagnostic data and the second prediction into a feedback module, wherein the diagnostic data includes data indicating one or more diagnostic events occurring at the machine;
determining, by the computing device at the feedback module, whether the second prediction is compatible with the diagnostic data; and
in response to the second prediction not being compatible with the diagnostic data,
receiving, by the computing device, second component data pertaining to a second time period, wherein the second time period occurs at least partially after the first time period, and
inputting, by the computing device, the second component data into the models module to perform at least one remediation process.

12. The computer-implemented method of claim 11, wherein the machine comprises a wind turbine.

13. The computer-implemented method of claim 11, wherein the remediation process comprises:
generating a training dataset based on the second component data; and
training the one or more computational models of the models module using the training dataset.

14. The computer-implemented method of claim 11, wherein the remediation process comprises inputting the first component data and the second component data into the models module of the predictive maintenance system to generate a third prediction.

15. The computer-implemented method of claim 11, wherein the first component data includes a condition parameter measured by a condition detector, wherein the condition detector comprises the sensor associated with the component.

16. The computer-implemented method of claim 15, wherein the sensor comprises at least one of:
a thermocouple;
an oil particle counter;
a vibration sensor; or
an acoustic emission transducer.

17. The computer-implemented method of claim 15, wherein the condition parameter includes at least one of:
a temperature;
a motion of the component; or
a presence of a predetermined element in the component.

18. A system for predictive maintenance using computational models, comprising:
at least one processor; and
a non-transitory storage medium with computer-readable instructions stored thereon, wherein the computer-readable instructions, when executed by the at least one processor, cause the at least one processor to:
receive first component data pertaining to a first time period, wherein the first component data includes data from at least one of a SCADA system or a CMS, and the first component data includes data generated from a sensor associated with a component;
input the first component data into a models module of a predictive maintenance system to generate a first prediction based on the first component data, wherein the models module includes one or more computational models;
input confidence interval data and the first prediction into a prediction module to generate a second prediction;
input diagnostic data and the second prediction into a feedback module, wherein the diagnostic data includes data indicating one or more diagnostic events associated with the component;
determine, at the feedback module, whether the second prediction is compatible with the diagnostic data; and
in response to the second prediction not being compatible with the diagnostic data,
receive second component data pertaining a second time period, wherein the second time period occurs at least partially after the first time period, and
input the second component data into the models module to perform at least one remediation process.

19. The system of claim 18, wherein the computer-readable instructions further cause the at least one processor to input assumption data into the models module, wherein the assumption data includes at least one of:
an upper bound of a condition parameter;
a lower bound of a condition parameter; or
a threshold value of a condition parameter.

20. The system of claim 18, wherein determining, at the feedback module, whether the second prediction is compatible with the diagnostic data comprises:
the second prediction including data indicating that the component is underperforming; and
the diagnostic data including data indicating that the component was repaired or replaced.
